(19) United States
(12) Patent Application Publication
(10) Pub. No.: US 2019/0029312 A1
(43) Pub. Date: Jan. 31, 2019

(54) Yogurt Crisp and Method for Making Same

(71) Applicant: Frito-Lay North America, Inc., Plano, TX (US)

(72) Inventors: Donna Jan DIERMEIER, Highland Village, TX (US); Pierre FAA, Frisco, TX (US); Emily WILSON, Little Elm, TX (US)

(21) Appl. No.: 16/150,519

(22) Filed: Oct. 3, 2018

Related U.S. Application Data
(62) Division of application No. 14/814,964, filed on Jul. 31, 2015.

(51) Int. Cl. A23P 30/10; A23L 7/135; A23L 33/135; A23P 20/20

(52) U.S. Cl. CPC A23P 30/10; A23P 20/20; A23L 33/135; A23L 7/135

(57) ABSTRACT

A significant amount of yogurt product is used to form a viscoelastic dough capable of being sheeted and cut, without sticking to equipment, and cooked, without over-browning from the high protein and sugar found in yogurt. A number of snack foods can be made with the dough, including a shelf-stable light and crunchy yogurt crisp with whole grain and optional inclusions.

### CROSS-REFERENCE TO RELATED APPLICATION

This application is a divisional of U.S. application Ser. No. 14/814,964 filed Jul. 31, 2015, the disclosures of which are incorporated herein by reference.

### BACKGROUND OF THE INVENTION

### Technical Field

A yogurt crisp and method for making same is described herein. More specifically, a product and method for delivering significant amounts of yogurt in snack foods is described herein, the method providing for both batch and continuous processes.

### Description of Related Art

Snack foods such as chips and crackers can be created by forming a starch dough, which is then sheeted or compressed between a pair of counter rotating sheeter/cutter rollers that are located closely together, thereby providing a pinch point through which the dough is formed into sheets. The sheeted dough is then cut into pieces, and the pieces are transported to a fryer or an oven, which cooks the pieces.

Yogurt is a popular, nutrient-dense food. To date, few snack foods are able to provide significant amounts of real yogurt to consumers and few shelf-stable (i.e., low moisture) snack foods are known to do so due to the negative effects the high protein and sugar found in yogurt can have on processing steps such as mixing, sheeting, shaping and cooking. There is a need for more snack foods that contain high amounts of yogurt without comprising taste, texture, or appearance. There is also a need for ensuring the dough used to make snack foods is sheetable, compressible, and transportable in light of additional processing steps for obtaining the desired food product and despite high amounts of starch therein. There is further a need for shelf-stable snack foods capable of delivering high amounts of yogurt without the need for refrigeration of the snack foods.

### SUMMARY OF THE INVENTION

Provided herein are yogurt snacks and ready-to-eat yogurt crisps (i.e., light and crisp baked snack foods) containing high amounts of yogurt. The yogurt crisps do not require refrigeration and are shelf-stable. Methods for manufacturing shelf-stable yogurt crisps in a continuous process without delays or disruptions within the equipment are also described.

Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

In one embodiment, a method for making yogurt snack foods comprises the steps of sheeting a dough lacking yeast to form a sheeted dough, said dough comprising, on a wet basis, at least about 15% dehydrated yogurt; about 16-25% starch, a moisture content of greater than about 26%; and up to 10% oil; cutting the sheeted dough to form a plurality of dough pieces; and drying the dough pieces. In one embodiment, the starch is a modified starch. In one embodiment, the modified starch is a pre-gelatinized cornstarch. The drying may comprise one or more dehydrating steps, which cook the dough pieces into a snack food piece having a moisture content ranging from about 0.8% to about 15%. In one embodiment, the dough pieces are dried to a moisture content of between about 0.8% and about 3% to form a plurality of ready-to-eat, shelf-stable yogurt crisps. Food products having a higher moisture content, however, such as bread, are also possible using the methods and formulations provided herein.

Shelf-stable, ready-to-eat yogurt crisps comprise at least about 20% yogurt; at least about 16% modified starch; and a moisture content of between about 0.8% to about 3%. Crisps as described herein may comprises a thickness of less than or about 0.25 inches. In one embodiment, the modified starch is a pre-gelatinized cornstarch. In one embodiment, the thickness is between about 0.07 and about 0.25 inches. In one embodiment, the yogurt crisp comprises a plurality of inclusions comprising a moisture content of between about 1% to about 10%. In one embodiment, each individual inclusion comprises a size of between about 1 to about 6 mm.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart of one embodiment for making a shelf-stable yogurt crisp as described herein.

FIG. 2 is a graphical representation of the viscosity curve of one embodiment of the dough.

FIG. 3 is a graphical representation of the moisture of several sample yogurt crisps over time during the drying step.

FIG. 4 is a typical RVA pasting curve of a starch-based component with low protein.

FIG. 5 is a graphical representation of the RVA pasting curve of two embodiments of a yogurt crisp as described herein.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. The term “consisting essentially of” limits the scope of a claim to the specified elements, steps or material(s) and those that do not materially affect the basic and novel characteristic(s) of the claimed invention. As used herein, “up to” includes zero, meaning no amount is added in some embodiments.

Several embodiments for snack foods described herein and methods for making same will now be described with reference to the figures. Unless otherwise noted, like elements will be identified by identical numbers throughout all figures.

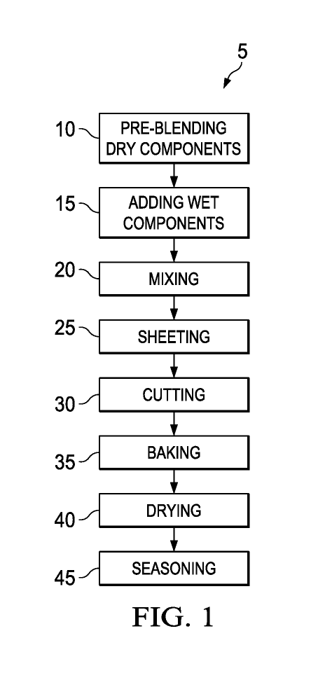

One embodiment of a method 5 of making a shelf-stable yogurt crisp will now be discussed in reference to FIG. 1. FIG. 1 is a flow chart of one embodiment for making a shelf-stable yogurt crisp. It should be noted that this figure is for illustrative purposes and is not meant to be limiting unless otherwise indicated. Other embodiments may comprise additional or optional step(s) not shown and/or step(s) may be omitted, slightly modified, or combined whereas other embodiments may have all the steps shown in FIG. 1. For example, in some embodiments, the step of pre-blending dry components 10 may be performed simultaneous with the step of adding wet components 15 and/or mixing 20 to form the dough. Alternatively, the substantially prepared dough may be obtained from another source and worked into the method described herein in other embodiments.

Generally, the method for making yogurt snack foods as described herein comprises the steps of sheeting a dough lacking yeast to form a sheeted dough, the dough comprising on a wet basis: at least about 15% dehydrated yogurt, between about 16 to about 25% starch, a moisture content of greater than about 26% and up to about 10% oil; cutting the sheeted dough to form a plurality of dough pieces; and drying the plurality of dough pieces to form a plurality of yogurt snack foods.

With reference to the embodiment depicted in FIG. 1, dry components to be used to form a dough are pre-blended 10 or combined and mixed in a batch, continuous or other mixer, thereby forming a dry blend. For the formation of yogurt snack foods as described herein, the dry blend must comprise dehydrated yogurt. In one embodiment, the dry blend for forming the yogurt dough comprises at least about 15% dehydrated yogurt. In one embodiment, the dry blend for forming the yogurt dough comprises at least about 20% dehydrated yogurt.

As used herein, “dehydrated yogurt” is meant to include yogurt powders, granules, flakes, agglomerates and/or any other dehydrated yogurt materials having protein and sugar amounts as typical of yogurt products. In one embodiment, for example, dehydrated yogurt may contain milk and/or whey proteins. In one embodiment, the dehydrated yogurt comprises a protein content of between about 20% and about 70%. In one embodiment, the dehydrated yogurt also comprises between about 15% and about 70% sugar. In one embodiment, the dehydrated yogurt comprises a protein content of between about 20% and about 70% and a sugar component of between about 15% and about 70%. In one embodiment, the moisture content of the dehydrated yogurt is less than about 40%. In another embodiment, the moisture content of the dehydrated yogurt is between about 2% to about 40%.

Other dry components for the dry blend include without limitation dry components containing or derived from wheat, oat, starch, sugar, baking soda, salt, emulsifier, hydrocolloids, enzymes, dairy, mineral, vitamin, fruit, and vegetable. In some embodiments, the dry blend also comprises inclusions such as nuts, seeds, chocolate, and/or dried fruit pieces or granules. In one embodiment, inclusions include dried fruits and vegetables other than those dried into powder form and comprising a moisture of between about 1% to about 10%. Oil may also be added to the dry blend in one embodiment. In one embodiment, the dry blend comprises calcium. “Calcium” may refer to any number of food-grade calcium powders readily available from any number of manufacturers including without limitation acid salts of calcium and calcium-based ionic compounds, such as calcium chloride.

In embodiments comprising lower moisture (such as shelf-stable products), the dry blend should comprise a modified starch. Modified starch refers to a starch that has been physically, enzymatically, or chemically modified from its native starch nature. In some embodiments, the starch within the dry blend may comprise one or more of whole wheat flour, oat flour and modified starch. In some embodiments, the starch within the dry blend may comprise two or more of whole wheat flour, oat flour and modified starch. In some embodiments, the starch within the dry blend may consist of whole wheat flour, oat flour and modified starch. In one embodiment, the modified starch is a pre-gelatinized starch, the degree of gelatinization of which can vary. In one embodiment, the pre-gelatinized starch is a pre-gelatinized cornstarch. For embodiments comprising higher moisture contents, a native starch (i.e., a starch isolated from a plant source without altering its chemical structure) may be used.

The protein and sugar amounts found within the dehydrated yogurt used to form the dough may create a sticky dough that is difficult to process. In some embodiments, one or more enzymes may also be added to the dough, whether in liquid or powder (i.e., solid) form, to reduce the stickiness of the dough to allow for better processing, or to strengthen the dough. Any number of enzymes that hydrolyze or breakdown molecules present in wheat flour to allow for better handling of the dough may be used. Such enzymes may or may not be necessary to allow for easier subsequent handling or processing, depending on the equipment or manner of subsequent processing steps. In one embodiment, the dry components or pre-blending step 10 may comprise between about 5 to about 100 ppm of an enzyme or an enzyme mixture in the pre-blended dry mixture.

In one embodiment, live probiotics may also be introduced into the dry components or pre-blending step 10. The probiotics may be in spore form, in one embodiment. In one embodiment, the probiotics may be microencapsulated to aid in their resistance to the processing conditions described herein. In one embodiment, a lactobacillus species of dry probiotics may be included within the pre-blending step 10. Probiotics may be added at an inclusion rate to allow for the desired colony forming units per serving, such as 500 million or 1 billion in the final product. The amount of probiotic addition may vary widely based on the resistance of the strain or strains used and the concentration of the probiotics. A heat stable strain, such as one readily available from manufacturers, may also be desirable.

In addition to the dehydrated yogurt, in some embodiments, the dry blend comprises wheat flour, oat flour, modified starch, sugar, baking soda, salt, emulsifier, calcium powder and optionally: one or more of: oil, inclusions, and a probiotic. In one embodiment, the dry components in the pre-blending step 10 comprise between about 20% to about 30% whole wheat flour, between about 5% to about 15% oat flour, between about 20% to about 30% modified starch, between about 5% to about 10% granulated sugar, between about 0.5% to about 2.0% baking soda, between about 0.2% to about 5% salt, between about 0.1% to about 1.0% lecithin powder, between about 0.2% to about 1.0% calcium powder; between about 20% to about 30% dehydrated yogurt, between about 1% and about 5% oil, and up to about 15% inclusions.

In one embodiment, the dry components in the pre-blending step 10 comprise between about 22% to about 26.5% whole wheat flour, between about 9% to about 11% oat flour, between about 20% to about 24.5% modified starch, between about 7% to about 9% granulated sugar, between about 1% to about 1.4% baking soda, between about 0.25% to about 0.35% salt, between about 0.5% to about 0.7% lecithin powder, between about 0.5% to about 0.6% calcium powder; between about 23% to about 28% dehydrated yogurt, between about 2.95% and about 3% oil, and up to about 15% inclusions.

Bulk density of the dry blend may vary somewhat, depending on whether or not inclusions are used or desired in the dough or final product. Inclusions may provide visibly appealing color, variable taste, or variable texture to the final products. The inclusions may also be desirable or useful to provide for docking of the dough. In one embodiment, the bulk density of the dry blend in the pre-blending step 10 is between about 0.7 and about 0.9 g/mL. In one embodiment, the bulk density of the dry blend in the pre-blending step 10 is between about 0.7 and about 0.8. In one embodiment, the bulk density of the dry blend in the pre-blending step 10 is between about 0.84 and about 0.89 g/mL. In one embodiment, the bulk density of the dry blend in the pre-blending step 10 is between about 0.74 and about 0.77. Table 1 below provides sample bulk densities of the dry blend created in the pre-blending step 10, along with the average bulk density of similar samples. Samples 1A, 1B, and 1C contained inclusions within the dry blend, while samples 2A, 2B, and 2C contained no inclusions.

TABLE 1
Bulk Densities of Example Formulations

| | Bulk Density | Bulk Density | Bulk Density |
|---|---|---|---|
| Sample | (g/ml) | (lb/cu. ft) | (oz/100 cu. in) |
| 1A | 0.89 | 14.23 | 51.47 |
| 1B | 0.87 | 13.85 | 50.11 |
| 1C | 0.84 | 13.45 | 48.66 |
| Average Bulk | 0.87 | 13.85 | 50.08 |
| Density | | | |
| 2A | 0.74 | 11.84 | 42.81 |
| 2B | 0.76 | 12.08 | 43.69 |
| 2C | 0.77 | 12.26 | 44.35 |
| Average Bulk | 0.75 | 12.06 | 43.62 |
| Density | | | |

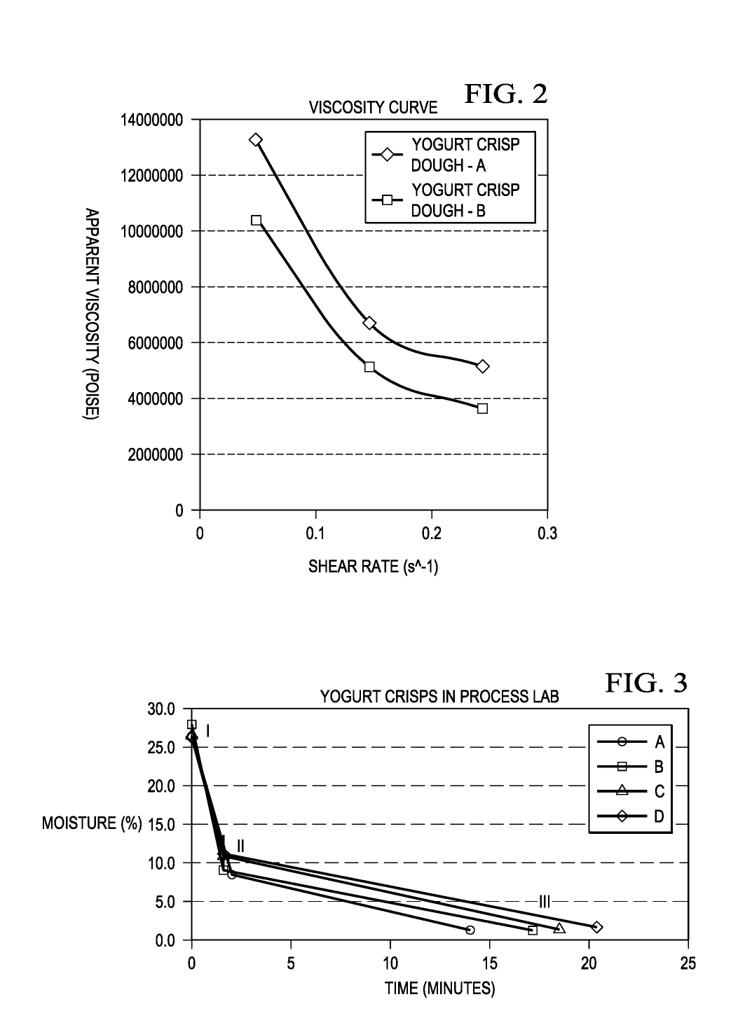

Referring back to FIG. 1, pre-blending 10 should take place until a cohesive mix of dry blend components is achieved. Mixing will depend upon the amount of dry blend components as well as the mixer used. In one embodiment, mixing is performed for between about 1 to about 5 minutes. During test runs, 25-lb batches were mixed for about 1 minute, for example; while a 500-lb batch was mixed for about 5 minutes. After pre-blending 10 to form a cohesive mix, wet components are added to the dry blend. In one embodiment, wet components added 15 may consist of only water. In other embodiments, however, any water-based component may also be added including, for example, juice, extract or puree. In one embodiment, chilled water or a chilled water-based liquid at a temperature of between about 50-80° F. is added to the dry blend. In one embodiment, the dough should comprise a moisture content of no less than about 30-31% moisture. In one embodiment, the dough comprises a target moisture of between about 27% to about 33%. In one embodiment, the dough comprises a target moisture of about 30-31% moisture. Mixing 20 then takes place for between about 1 to about 10 minutes to form a dough. Depending on the type of mixer, the dough mixing action will result in shear deformation (continuous mixing with an extruder) or elongated deformation (z-blade batch type of mixer). A suitable dough as described herein is a viscoelastic dough, and should be generally be less viscous than elastic to allow for the conveying of the dough from the mixer to the conveyor belt. FIG. 2 demonstrates the rheological properties of two sample doughs (A & B), with and without inclusions, successfully used herein. The viscosity curve for the dough, showing the shear rate vs. apparent viscosity, falls in line with Bostwick viscosity testing results obtained, in which very little to zero movement was shown for the dough, even after 18 hours. When there is little to no shear rate, the dough has a very high viscosity. Following mixing 20 to form the dough, in one embodiment, the dough is then deposited or transferred onto a conveyor belt or transport system for sheeting 25. In one embodiment, the depositing step occurs in a continuous process. However, the dough may also be manually deposited onto a belt system. In some embodiments, the dough may be transferred or baked in any oven used for baking bread, for example.

Sheeting may occur in one or more steps. In one embodiment described herein for a continuous process of production, the dough is transferred to a conveyor belt and may be sheeted 25 using one or more sheeting or reduction steps or zones while moving along the conveyor belt. In one embodiment, the dough thickness is reduced by between about 30% to about 80% with each reduction or sheeting step. In one embodiment, the dough thickness is reduced by between about 50% with each reduction or sheeting step. The reduction may depend on the initial dough thickness or desired end product. However, in embodiments for the formation of a plurality of shelf-stable yogurt crisps, the dough is sheeted to a thickness of no more than about 0.2 inches. In one embodiment, the dough is sheeted to a thickness of between about 0.086 and about 0.88 inches. In some embodiments, for example, the thickness of the dough from a first sheeting step to a final sheeting step is at least 90%.

Any number of sheeting devices or methods may be used to roll or compress the dough into a dough sheet with a substantially uniform thickness, including without limitation compression between two or more rotating rollers. As used herein, the term “substantially” refers to the complete or nearly complete extent or degree of an action, characteristic, property, state, structure, item, or result. The exact allowable degree of deviation from absolute completeness may in some cases depend on the specific context and can be determined by one skilled in the art, armed with this disclosure. However, generally speaking the nearness of completion will be so as to have the same overall result as if absolute and total completion were obtained.

During trial runs, up to three reduction stations comprising compression between two rotating rollers were used to sheet the dough to the desired even dough thickness. In some embodiments, one or more sheeting steps may be performed on cloth, cotton/poly blend, or plastic conveyor belts to help deal with any stickiness of the dough. In one embodiment, chilled rollers (about 30° F. to 50° F.) may be used to sheet the dough. A pre-cutter airstream bar prior to a roller system may also be employed to dry the surface of the dough and reduce stickiness.

Following sheeting 25, the dough may be optionally docked to prevent formation of large air pockets during baking or cooking steps, depending on the desired end product. In one embodiment, inclusions such as dried fruits or vegetables, as described above, may be sprinkled onto the dough after sheeting. In one embodiment, the inclusions may be sprinkled on top of sheeted dough (after one or more sheeting steps) but before a final sheeting step. In one embodiment, a cutter with docking pins or a separate docking station may be used to avoid any undesirable smearing or smashing of inclusions with large reduction rollers.

Sheeted dough is then cut 30 into desired shapes or pieces. In one embodiment, the dough is simultaneously sheeted or rolled 25 and cut 30 into a plurality of dough pieces using a cutter roll or similar cutting device.

It should be noted that pre-blending step 10, adding step 15, mixing step 20, sheeting step 25, and cutting step 30 each occur at ambient temperatures of between about 60° F. to about 90° F. The cut pieces may be configured in any number of shapes or sizes, whether or not the cutter minimizes any wasted dough, including, for example, squares, strips, triangles (whether straight or curved edges), hexagons, circles, etc.

Generally, the cut pieces from the cutting step 30 undergo one or more cooking or dehydrating steps. While FIG. 1 depicts two cooking steps 35, 40, one skilled in the art, armed with this disclosure, will appreciate that a single heating step may also be used to arrive at a desirable product. With reference to the embodiment depicted in FIG. 1, the cut pieces undergo a two-stage cooking process wherein the cut pieces first undergo a baking step 35, followed by a second cooking step in the form of drying 40. In one embodiment, baking is performed at temperatures of about 415° F. or less. In one embodiment, baking is performed at temperatures of about 415° F. or less, followed by drying at temperatures of about 260° F. Parameters related to baking 35 and drying 40 steps will depend on the desired end product, as will be further described below. Following drying 40 to the desired moisture in the product, the finished product may then undergo a seasoning step 45 with any number or combination of desired seasonings, oils, or flavor sprays.

In one embodiment, seasoning step 45 comprises topical application of probiotics. Topical probiotics may, for example, be added onto a final product with zero probiotics in the base or finished product in one embodiment. That is, 100% of any probiotics on a finished product may consist of dry powder probiotics topically applied to the finished product in one embodiment. In another embodiment, probiotics may be added into the dough and also topically applied. In one embodiment, about 50% of the probiotics used may be incorporated into the dough and about 50% of the probiotics used may be topically applied onto the snack product. Topical addition of probiotics may comprise mixing dried probiotics in with one or more powdered seasonings. In one embodiment, probiotics are added into the dry component mix or dry blend in the formation of the dough in the range of between about 0.2% to about 0.4% of the dry components and in the range of between about 0.2% to about 0.4% in a seasoning mixture topically applied to the finished product.

In one embodiment, the dough pieces are dried to an oven exit moisture of about between 6% and 15%, followed by drying to a dryer exit moisture of about 0.8% to 3%. Baking 35 may be performed in a multizone oven. Drying 40 may be performed in a dryer for between 10 and 25 minutes at between about 230° F. to about 270° F. Monolayer arrangement of pieces may be dried in less time. Additional drying steps in the same dryer over or with an additional drying apparatus may be performed if necessary to attain the desired moisture content. Table 2 below contains oven settings used in one embodiment in the formation of shelf-stable, ready-to-eat yogurt crisps. Table 3 provides dryer settings used in the same embodiment. Longer or shorter oven or dryer dwell times or higher temperatures within the range described herein may be used depending on the desired end products.

TABLE 2
Oven Settings for Yogurt Crisp Embodiment

| 2.25 min Bake Time | Zone 1 | Zone 2 | Zone 3 |
|---|---|---|---|
| Temp (° F.) | 375 | 375 | 320 |
| Circulation (%) | 30 | 60 | 90 |
| Exhaust (%) | 10 | 50 | 100 |

TABLE 3
Dryer Settings for Yogurt Crisp Embodiment

| | |
|---|---|
| Temp Top Zone (F.) | 245 |
| Total Time Zone 1 (min) | 15.5 |
| Exhaust Fan (Hz) | 60 |
| Recirculation, Top and Bottom (Hz) | 60 |

In embodiments incorporating probiotics into the dry component blend 10 in the formation of the dough, oven temperatures for baking 35 may be slightly reduced to increase survivability of the probiotics. Additionally, higher amounts of probiotics may also be used, depending on the moisture content and specific end product desired. Intermediate-type moisture products such as bread will not necessitate as much drying time as shelf-stable products, for example. During test runs an increase of about 32% probiotics in the dough increased survivability of the probiotics in the finished product by about 20%. One skilled in the art, armed with this disclosure, will be able to adjust the amount of probiotics or processing conditions depending on the desired end product. In one embodiment, a method of incorporating probiotics into the dough and final product comprises mixing dry components 10 (including the probiotics), adding wet components 15 and mixing to form the dough, forming or shaping dough pieces from the dough, and drying the shaped pieces at about 350° F. to about 400° F. for between about 1-3 minutes, and then at about 270° F. or less for between about 10 to about 15 minutes to a finished product moisture of less than about 4%.

The moisture loss during the cooking of the dough to form a shelf-stable product in the form of yogurt crisps in one embodiment is reflected in FIG. 3. Samples A-D of a dough formed into cut pieces as described above were evaluated for moisture data at points I-III. At point I is shown the moisture of Samples A-D after the cutting step 30. For purposes of the data presented in FIG. 3, the dough was cut into a plurality of pieces using a 34 mm circle cutter (wt/5=14.5 grams). After baking in an oven at between about 350° F. to about 375° F. for about two minutes, the moisture of the baked dough pieces was measured at point II in FIG. 3. Drying at a temperature of about 260° F. for about 14 minutes resulted in the moisture shown generally at point III along the graph, which is generally about 0.9% to about 1.5% moisture. Table 4 below indicates actual data measurements for Samples A-D in the formation of the graph shown in FIG. 3.

TABLE 4
Yogurt Crisp Embodiment Moisture During Cooking

| | Dough | | | | |
|---|---|---|---|---|---|
| | Piece | Time in | OVEN | Time in | FINISH |
| | Moisture | oven | MOISTURE | Dryer | MOISTURE |
| Sample | (%) | (min) | (%) | (min) | (%) |
| A | 28.72 | 2.00 | 11.39 | 14.00 | 1.32 |
| | 26.56 | 2.00 | 10.95 | 14.00 | 1.23 |
| | 26.73 | 2.00 | 4.72 | 14.00 | 1.37 |
| | 27.85 | 2.00 | 7.77 | 14.00 | 1.09 |
| | 27.92 | 2.00 | 7.36 | 14.00 | 1.15 |
| Average | 27.1 | 2.0 | 8.4 | 14.0 | 1.2 |
| Moisture of | | | | | |
| Sample A | | | | | |
| B | 26.49 | 1.60 | 10.28 | 13.00 | 1.40 |
| | 27.87 | 1.60 | 8.15 | 15.00 | 1.23 |
| | 28.09 | 1.60 | 11.41 | 18.00 | 0.92 |
| | 26.84 | 1.60 | 8.37 | 19.00 | 1.23 |
| | 27.91 | 1.60 | 7.36 | 19.00 | 1.15 |
| | 29.61 | 1.60 | | 19.00 | 1.23 |
| Average | 27.8 | 1.6 | 9.1 | 17.2 | 1.2 |
| Moisture of | | | | | |
| Sample B | | | | | |
| C | 26.21 | 1.60 | 8.00 | 19.00 | 0.92 |
| | 26.50 | 1.60 | 10.18 | 17.00 | 1.38 |
| | 26.67 | 1.50 | 12.90 | 19.00 | 1.40 |
| | 27.23 | 1.50 | 12.90 | 19.00 | 1.81 |
| Average | 26.7 | 1.6 | 11.0 | 18.5 | 1.4 |
| Moisture of | | | | | |
| Sample C | | | | | |
| D | 25.86 | 1.60 | 9.30 | 19.00 | 0.95 |
| | 25.28 | 1.60 | 10.33 | 20.00 | 1.73 |
| | 25.71 | 1.60 | 9.83 | 21.00 | 1.55 |
| | 27.88 | 1.60 | 14.11 | 21.00 | 1.85 |
| | 26.29 | 1.60 | 11.90 | 21.00 | 2.07 |
| | 28.52 | 1.50 | 17.33 | 21.00 | 1.31 |
| | 28.86 | 1.50 | 17.96 | 21.00 | 2.84 |
| | 28.52 | 1.50 | 13.36 | 21.00 | 1.38 |
| | 27.66 | 1.50 | 14.51 | 21.00 | 2.47 |
| Average | 26.2 | 1.6 | 11.1 | 20.4 | 1.6 |
| Moisture of | | | | | |
| Sample D | | | | | |

The high amount of protein provided by the significant amount of yogurt powder in the present invention presents a challenge in that the dough retains a lot of moisture and the potential for overbrowning or overexpanding. Thus, the baking profile should comprise a low temperature (i.e., temperatures ranging from about 315° F. to about 415° F.) and an increasing amount of airflow. In one embodiment, the airflow increases from 30% to 90% in the first drying apparatus. Typically, prior art crackers, for example, will be baked at a higher range of between about 450° F. to about 500° F. with a more progressive decrease in moisture. With the present dough pieces, however, it is preferable to use a slower baking and/or drying processes to reduce browning. As shown in FIG. 3, for example, a slower drying time of up to about 30 minutes may be needed, depending upon the end product desired.

In one embodiment, a finished shelf-stable (i.e., low moisture of less than about 2-4%), ready-to-eat yogurt crisp comprises between about 20% to about 25% yogurt powder in addition to one or more of the following: between about 18% to about 22% whole wheat flour, between about 18% to about 22% pre-gelatinized starch, between about 7% to about 10% oat flour, between about 6% to about 9% granulated sugar, between about 0.8% to about 0.15% baking soda, between about 0.1% to about 0.3% salt, between about 0.3% to about 0.7% emulsifier, between about 0.3% to about 0.6% calcium, less than 3% oil, up to 5% topical seasoning, up to 5% topical oil, and less than 2% moisture.

As used herein, a “shelf-stable yogurt crisp” is a light and crisp baked snack food product containing a significant amount of yogurt, which does not require refrigeration and is stable at typical ambient conditions for at least a month and potentially, for example, up to 9 months. A shelf-stable product is microbiologically safe and does not show significant organoleptic differences between the aged product and the fresh product. Thus, the yogurt crisp described herein may be packaged for later sales and/or consumption or eaten upon drying to the desired moisture content, with little to no negative affects on taste or texture. The crisps described herein are especially desirable and beneficial shelf-stable products due to their crunchy texture and the incorporation of high amounts of yogurt without the need for refrigeration. In one embodiment, a crisp may comprise a thickness of less than or about 0.25 inches.

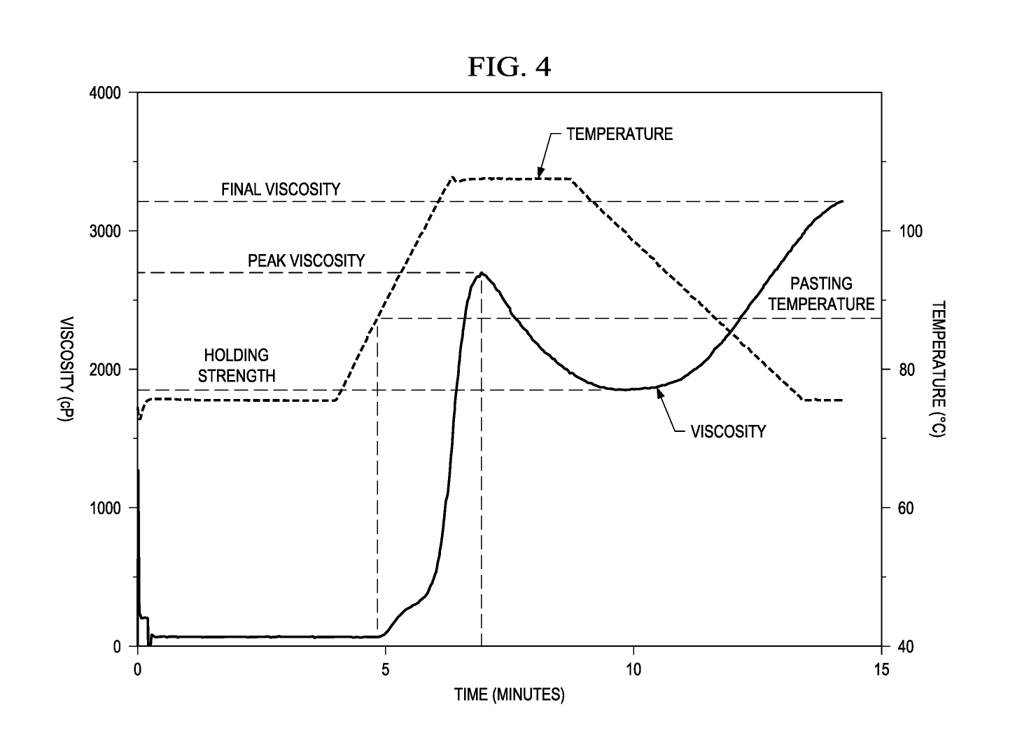

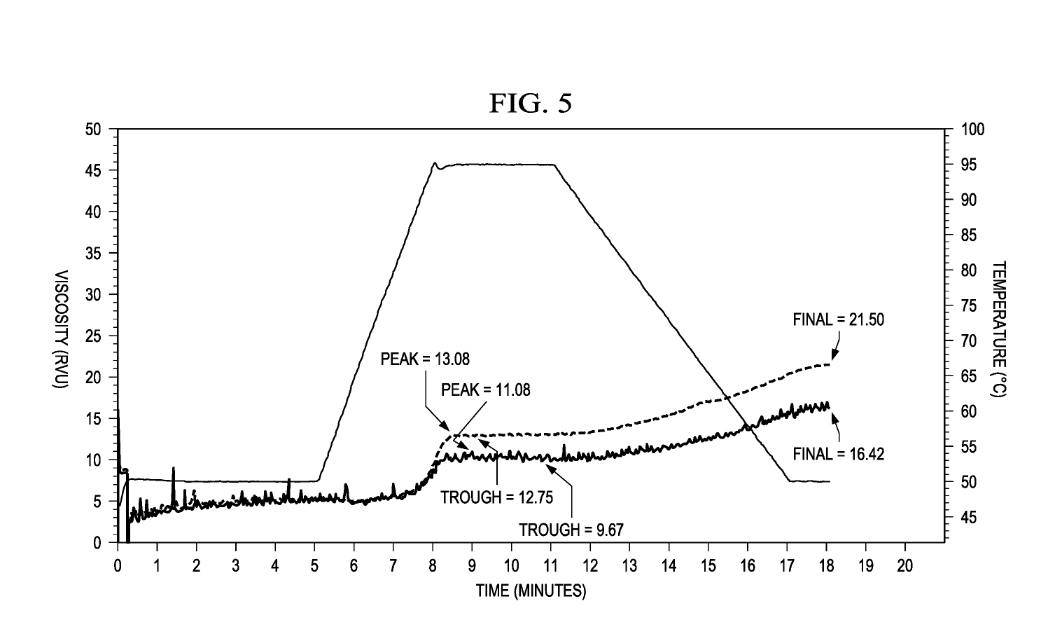

To better reflect the shelf-stable yogurt crisp embodiment, FIGS. 4 and 5 reflect the contrast between the typical Rapid Visco Analyzer (RVA) pasting curve of a typical high starch cracker (FIG. 4) and the RVA pasting curve of a finished yogurt crisp product (FIG. 5). The RVA is a rotational viscometer that incorporates variable heating, cooling and shear capabilities. Standardized test profiles are available, including those approved by the American Association of Cereal Chemists (AACC International) and the International Association for Cereal Science and Technology (ICC). RVA is a rotational viscometer that continuously records the viscosity of a sample under conditions of controlled temperature and shear. The combination of shearing, heating, and cooling applied over time, creates a viscosity curve for a material. In standard starch analysis, starch is heated in an aqueous setting. Starch granules take up water and swell, the internal crystalline structure melts (gelatinization), the granule breaks down and a continuous gel forms. The viscosity changes produced by heating and cooling starch in water generally provide a similar characteristic pasting curve.

As mentioned above, FIG. 4 reflects a typical RVA pasting curve for a prior art starch cracker with a moisture content of about 3.35%. At the bottom left of the graph, the pasting temperature provides an indication of the minimum temperature required to cook a sample. Peak viscosity indicates the water-holding capacity of the starch or mixture. It is often correlated with final product quality, and also provides an indication of the viscous load likely to be encountered by a mixing cooker. The peak viscosity of the prior art starch cracker is about 113.92RVU and the trough viscosity is about 78.17RVU. The rate of breakdown in viscosity to a holding strength, hot paste viscosity or trough, depends on the temperature and degree of mixing, or shear stress, applied to the mixture, and the nature of the material itself. Final viscosity (at about 135.75 RVU), at the top right of the graph, is used to define the sample's quality and indicates the ability of the starch to form a viscous paste or gel after cooking and cooling. FIG. 5 shows two curves, reflecting two different embodiments of a yogurt crisp as described herein. The lower curve is a yogurt crisp embodiment with fruit inclusions and the curve with the greater peak is one without fruit. The initial hydration is as expected for both embodiments depicted therein, and the viscosity then reaches a peak as expected. The first peak is likely due to the starch; however, the second peak is likely due to the high protein content of the dough. The higher amount of protein is not fully hydrated during the typical RVA test.

Fracturability of the yogurt crisp embodiment was also measured using known textural profile analysis testing with a 45 mm compression plate at a speed of 10 mm/second using 75% strain. In embodiment lacking inclusions, fracturability occurs generally between about 428 grams and about 1400 grams. In embodiments with inclusions, fracturability occurs generally between about 405 grams and about 2000 grams. Generally, embodiments with inclusions versus similar formulations without inclusions are more prone to fracturing and have more fraction points.

The methods described herein may be performed on a batch or continuous basis. Thus, in one embodiment, the method described is a continuous process, meaning a process that operates with a substantially or entirely uninterrupted flow of materials into and/or resulting from the process. In one embodiment, a continuous process is one that creates a throughput of at least about 250 lbs/hour. In one embodiment, a continuous process is one that creates a throughput of about 500 lbs/hour. In one embodiment, a continuous process may also include one or more steps performed manually or by other batch-wise means.

In one embodiment, a shelf-stable, ready-to-eat yogurt crisp comprises at least about 20% dehydrated yogurt, at least about 16% modified starch, and a moisture content of between about 0.8% to about 3%. In one embodiment, a crisp in accordance with any embodiment in this paragraph comprises between about 16% to about 25% modified starch. In one embodiment, the modified starch of the crisp is a pre-gelatinized cornstarch. In one embodiment, the crisp of any embodiment in the paragraph comprises up to about 10% oil. In one embodiment, a crisp of any embodiment in this paragraph comprises a starch, the starch comprising one or more of wheat flour and oat flour. In one embodiment, a crisp of any embodiment in this paragraph comprises a probiotic. In one embodiment, a crisp of any embodiment in this paragraph comprises between about 0.2% to about 10% emulsifier. In one embodiment, a crisp of any embodiment in this paragraph comprises inclusions; the inclusions comprising any one of: dried fruits, dried vegetables, nuts, seeds, chocolate, and any combination thereof. In one embodiment, a crisp of any embodiment in this paragraph comprises between about 5% to about 15% dried fruit inclusions. In other embodiments, a crisp of any embodiment in this paragraph also comprises one or more of any component mentioned as suitable for shelf-stable ready-to-eat yogurt crisp embodiments.

In one embodiment, a method for making yogurt snack foods comprises the steps of: sheeting a dough lacking yeast to form a sheeted dough, cutting the sheeted dough to form a plurality of dough pieces, and drying the dough pieces to form a plurality of yogurt snack foods. The dough comprises in one embodiment (on a wet basis): at least 15% dehydrated yogurt, between about 16% to about 25% starch, a moisture content of greater than about 26% and up to about 10% oil. In one embodiment of a method for making yogurt snack foods as described in any embodiment of this paragraph, the drying step comprises one or more dehydrating steps to achieve a moisture content of about 0.8% and about 3%, wherein the starch is a modified starch, thereby producing a plurality of ready-to-eat, shelf-stable yogurt crisps. In any embodiment found within this paragraph, the method may also comprise a forming step prior to sheeting, the forming step comprising combining dry components with water and optionally oil to form the dough. In any embodiment found within this paragraph, the method also comprises the step of depositing the formed dough onto a conveyor belt. In any embodiment found within this paragraph, the dough is sheeted while moving along a conveyor belt. In any embodiment found within this paragraph, the sheeting step comprises multiple reduction steps. In any embodiment found within this paragraph, the dough comprises a probiotic. In any embodiment found within this paragraph, the dough comprises a moisture content of about 28% to about 32% before the drying step. In any embodiment found within this paragraph, the cutting step comprises simultaneously rolling and cutting the dough into the dough pieces. In any embodiment found within this paragraph, the drying step comprises a baking step and an additional drying step. In any embodiment found within this paragraph, the drying step comprises baking at temperature of about 415° F. or less, optionally for between about 1 to about 3 minutes.

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

The methods disclosed herein may be suitably practiced in the absence of any element, limitation, or step that is not specifically disclosed herein. Similarly, specific snack food embodiments described herein may be obtained in the absence of any component not specifically described herein. Thus, the yogurt crisps described herein may consist of those listed components as described above.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A viscoelastic dough for making a shelf-stable ready-to-eat yogurt crisp with a moisture content of between about 0.8% to about 3%, said dough comprising:
at least about 20% dehydrated yogurt, said dehydrated yogurt comprising yogurt powders, granules, flakes or agglomerates, wherein the moisture content of the dehydrated yogurt is less than about 40%;
at least about 16% modified starch, wherein the modified starch is pre-gelatinized; and
a starch comprising one or more of wheat flour and oat flour;
wherein said dough lacks yeast.

2. The viscoelastic dough of claim 1 comprising between about 16% to about 25% modified starch.

3. The viscoelastic dough of claim 1 wherein the modified starch is a pre-gelatinized cornstarch.

4. The viscoelastic dough of claim 1 comprising up to about 10% oil.

5. The viscoelastic dough of claim 1 further comprising a probiotic.

6. The viscoelastic dough of claim 1 further comprising between about 0.2% to about 10% emulsifier.

7. The viscoelastic dough of claim 1 further comprising inclusions, said inclusions comprising dried fruits, dried vegetables, nuts, seeds, chocolate and any combination thereof.

8. The viscoelastic dough of claim 7 comprising between about 5% to about 15% dried fruit inclusions.

9. The viscoelastic dough of claim 1 comprising between about 20% to about 25% yogurt powder and one or more of: about 18% to about 22% whole wheat flour, between about 18% to about 22% pre-gelatinized starch, and between about 7% to about 10% oat flour.

10. The viscoelastic dough of claim 1 comprising between about 22% to about 26.5% whole wheat flour, between about 9% to about 11% oat flour, between about 20% to about 24.5% modified starch, between about 7% to about 9% granulated sugar, between about 1% to about 1.4% baking soda, between about 0.25% to about 0.35% salt, between about 0.5% to about 0.7% lecithin powder, between about 0.5% to about 0.6% calcium powder; between about 23% to about 28% dehydrated yogurt, between about 2.95% and about 3% oil, and up to about 15% inclusions.
